(19) United States
(12) Patent Application Publication
(10) Pub. No.: US 2005/0199748 A1
(43) Pub. Date: Sep. 15, 2005

(54) Structural fire protection system

(76) Inventors: Joel C. Heil, Tulsa, OK (US); Bart T. Baker, Mounds, OK (US)

Correspondence Address: Robert E. Massa, 1535 South Memorial, Tulsa, OK, 74112-7046, US

(21) Appl. No.: 10/797,174

(22) Filed: Mar. 10, 2004

(51) Int. Cl. E05G 1/00

(52) U.S. Cl. 239/208

(57) ABSTRACT

Our invention describes a fire protection system for a structure, such as a building, which may be operable as desired, or found necessary, by a building tenant, to protect against the possibility of a building fire or to extinguish a fire already occurring. Our system comprises a source of water which supplies water to a holding tank positioned near the structure, an electrically operable pump component connected to the holding tank and to a multiplicity of sprinkler members positioned at convenient locations on or in the structure. Sprinklers are intended to be mounted on the most convenient positions on the roof or sides of a building. Preferably, when mounted on the roof, sprinklers are to be connected to water supply lines positioned on the interior of the structure, when possible, for better appearance, and, for buildings having limited space below the roof, sprinklers are mounted on a fake ridge support system with water lines below the ridge system. Our system is developed to be made operable at the will of t4he tenant, or actuable automatically, or from a remote signal. The ultimate in fire protection is intended. The system includes proper inspection and clean-out components where needed for parts of the system

### FIELD OF THE INVENTION

Our invention relates to fire protection systems. More particularly, our invention relates to fire protection systems which are adaptable for construction upon a structure to protect flammable material from fire damage by adequately spreading water over a structure. Still more particularly, our invention relates to fire protection systems which may be positioned upon a flammable structure upon which danger from fire damage would be most likely to occur.

### BACKGROUND OF THE INVENTION

We have been in the construction business for many years and have never seen a fire protection system for a flammable structure, such as a domestic house, or even large warehouse, even remotely related to the type of protection system which we have developed.

For instance, we are aware of grass fires and even forest fires, in certain areas, like California, where the fire races rapidly across the dry grass and quickly consumes trees and unprotected structures, even causing extreme danger to people living there.

In such fires, the blaze is too widespread to be controllable by any action from a fire truck, either in anticipation of a blaze, or while a fire is consuming the structure, and particularly because there might be too many structures burning.

We believe our invention is thoroughly adequate to prevent and control a fire which may be threatening a structure. Fire involving a single structure might or might not be preventable or controllable by a single fire truck, but if there are several structures reacting to a grass fire or forest fire, any prevention or control would be impossible.

In studying and developing our invention, we have established our system to provide a number of adaptable components and controls to provide a system which is necessary and quickly adaptable for the various conditions pertaining to the particular structure involved.

We have made our system adaptable for use either in connection with a governmental source of water or by having an independent manner of water supply. Many structures are placed in the most dangerous areas, as in rural areas where there is no central water supply, even in California or Oklahoma. If there is no utility supply, those structures are at a great risk.

Also, we have a system which is adaptable to receive its electric power from either a local utility supply or by use of its own power, supplied either by batteries or by a generator. We have recognized that this might be necessary because it is always possible that a large grass fire might have already disabled the source of utility power. Then, we know that a good fire protection system must be adaptable to many very different kinds of structures, especially as to different sizes and designs. Therefore, we have made our system adaptable to the structure it is to protect. We describe herein the versatility of our system.

We have essentially considered the following two basic concepts in designing our invention: prevention and control.

First, in providing fire prevention, we have defined this as a matter of anticipation of fire hazards combined with a practical manner of protecting the structure.

Secondly, in fire control, we are considering a manner of fire protection after a fire might have started already.

To accomplish these two factors we have designed a system of providing sufficient spraying of water over the most necessary areas of a structure along with the most convenient manner of controls to direct that system.

The structure and any occupants must be protected before, during, and after any fire.

We have been in the construction business long enough that we have not been aware of any type of fire protection system, so we did not feel that it was to necessary to conduct any type of patent search.

### SUMMARY OF THE INVENTION

The primary object of our invention is to provide a fire protection system which is simple in construction, efficient in operation, and convenient to use.

Another object of our invention is to provide a fire protection system which is easily adaptable to the structure with which it is constructed and adaptable to provide ample protection.

Another object of our invention is to provide a fire protection system which is easily adaptable for necessary construction modification to conform to subsequent construction changes of any structure.

Still another object of our invention is to provide a fire protection system which is quickly adaptable to a form of electric power which is most easily supplied.

Still another object of our invention is to provide a fire protection system which has control systems adaptable to the particular requirements of the structure.

As we developed our invention, we constantly observed that many factors determined the ultimate requirements of a particular fire protection system. The size of the structure to be protected is primary. This size may be from a simple, completely wooden structure to a large, partly flammable structure which provides elemental protection for highly flammable components. Or, the filter protection system might be constructed in a manner of properly cooperating with a highly ornamental structure by obscurely constructing many features of the protection system. Or, in some cases, a structure might need the fire protection system to be constructed to more adequately protect some portions of the structure than others.

We have developed our system to be adaptable to the particular structure involved, the area included, and in consideration of the climatic conditions of the area. Thus, in consideration of one disaster which might befall the area and structure being protected, we have developed our system to be adaptable to operate by either electric power as supplied by a utility company or to the electric power supplied from a battery system. In event of a serious grass fire, it is likely possible the utility power would not be operating, thereby requiring the battery system to function.

Since the source of water for our system is provided by a large holding tank, most such tanks are normally placed underground near the structure, some consideration must be given to the climatic conditions in the area. In extreme cold, the water lines or controls must be protected from frost conditions, usually gained by being placed the frost line.

A tremendous amount of water must be supplied for the fire protection of a large structure. Therefore, not only do we provide for a large holding tank for the water, but we also provide means for collecting and returning to the tank as must water as the system will accumulate, in the most efficient manner, water that has been sprayed.

Then, the above objects and advantages of our invention will become apparent from our description of the following preferred embodiments of our invention.

### BRIEF DESCRIPTION OF THE DRAWINGS

FIG. 1 is a side elevational view, partly schematic, of a fire protection system according to our invention.

FIG. 2 is a side elevational view of a portion of a fire protection system according to our invention showing a structure with components of our invention positioned upon the roof and soffitt of a structure.

FIG. 3 is a partial side view of a component of a fire protection system according to our invention in position upon a soffitt of a structure.

FIGS. 4 and 5 are partial side view and end view, respectfully, of a fire protection system according to our invention showing an alternate style of the system as it would be in position upon a false roof of a structure.

FIG. 6 is a side view, partly schematic, of components of a fire protection system according to our invention showing one type of tank component and connections.

### DESCRIPTION OF THE PREFERRED EMBODIMENTS

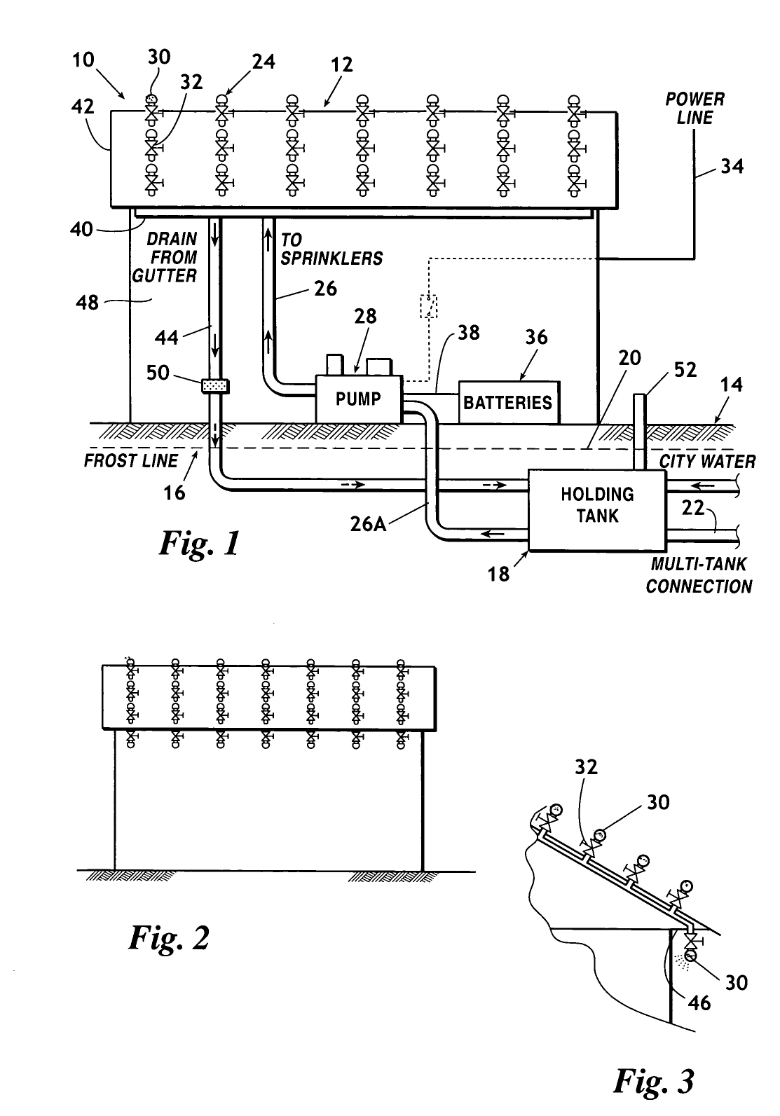

In FIG. 1 we describe a fire protection system 10, generally, as it would be interconnected with a typical building structure 12, generally, to provide fire protection to building structure 12, generally. In this situation, we are showing a fire protection system 10, generally, as it would be installed in a typical cold climate area with certain connections positioned underground, below earth 14 showing a frost line 16.

We have positioned a holding tank 18, generally, which receives a supply of water from a connection to a city utility water line 20, generally. We have calculated that for even a small structure, holding tank 18, generally, should be of at least 8,000 to 10,000 gallon capacity. Then, depending upon the size of any larger or more complex structure, holding tank 18 might have to be much larger, or the system might have to include additional holding tanks (not shown) as we indicate by showing a multi-tank connection 22.

As we explain in our description, our protection system includes a multiplicity of sprinkler components which comprise sprinkler heads 24, generally, positioned at the most convenient places on structure 12, as shown in our diagrams. Each sprinkler head 24 is connected to a water passage line 26 by a simple connection and water passage line 26 is connected to a pump 24, generally, which is electrically driven and is further connected to water holding tank 18 by water passage line 26A, to receive water from the holding tank 18 and deliver under force to each sprinkler head 24.

As we mentioned above, each sprinkler head 24, generally, is made to be adjustable, both in direction of water spray and in adjustment of the volume of flow. Each sprinkler head 24, generally, includes a multiplicity of flow openings 30 which provide direction for the flow, and a valve member 32, for properly controlling the volume of the water flow as preferred thru each sprinkler head 24.

As we mentioned, the electric power to the pump may be supplied either by power from a utility power line 34, or by power from a battery source 36 thru battery line 38, or may be provided by a generator system (not shown).

As we described above, we provide for collection and return of a portion of water spray from the structure by means of collection from the structure, as shown by connection of a typical gutter 40 at the edge of roof 42 of the structure 12 and return flow of water thru return water line 44, providing passage from the gutter 40 to holding tank 18.

In FIG. 2 we show additional sprinkler heads 18 mounted on a structure as being mounted on roof 42 and sprinkler heads mounted on a soffitt 46 by being aimed toward a side of the structure. Soffitt 46 comprises a typical overhanging portion of the structure, such as extending beyond the side wall of the structure 12.

We are aware that the various water lines are possibly collecting, at times, slight impurities or particles, therefore, we provide for the use of clean-out openings or filter components at convenient places in the system. We show a removable filter component 50 in the return water line 44. Such filter means may be placed at other convenient places in the system. Then, we have provided an inspection opening 52 in connection with the holding tank 18 to provide access as needed to properly service the holding tank. Also, we have provided for an overflow valve (not shown) to be positioned in the holding tank 18, and a winter bleeder valve (not shown) on the water supply line 20, as needed, and for a suitable form of emergency electrical switch, if needed for control of the pump 28. Today there are several types of electrical switch controls which are available for the most efficient and safest operation of our system in addition to the usual manual or heat controlled switches that would be used, such controls as including components which are remotely actuated, or controls which automatically notify an outside alarm system about the danger. We even anticipate the preparation of various forms of notices that may be placed at convenient positions on the property to advise any emergency workers about the existence and capability of the fire protection system.

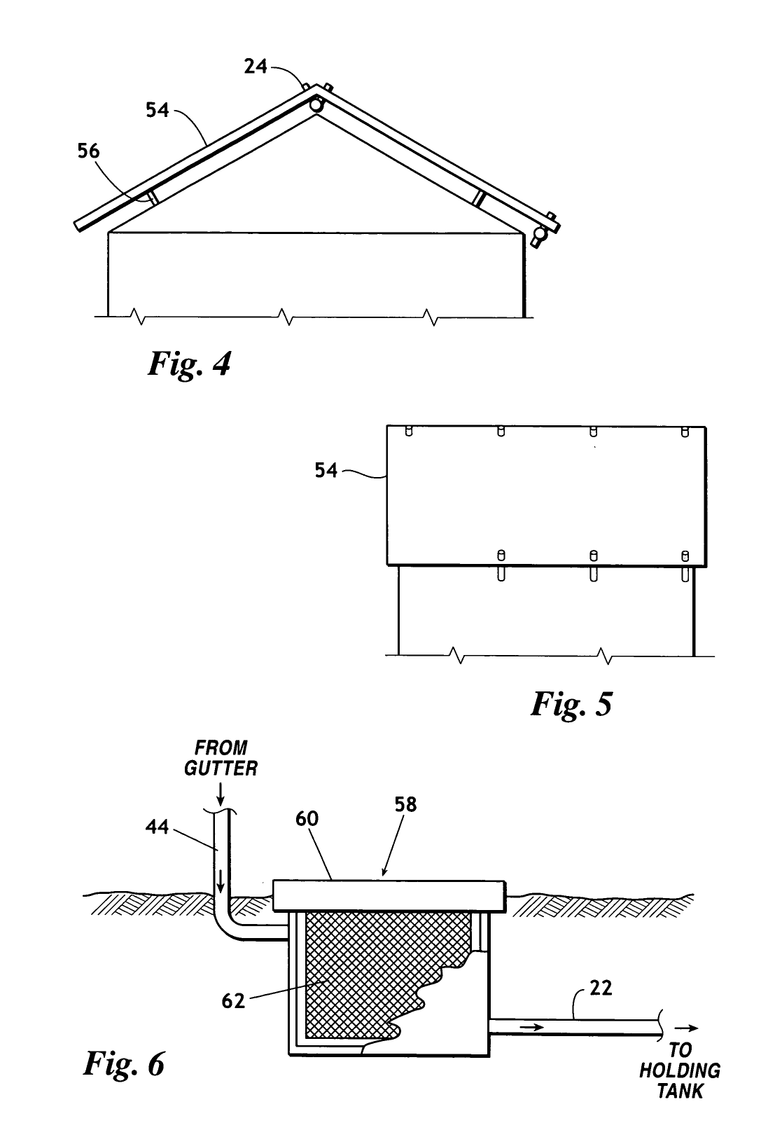

In FIGS. 4 and 5 we describe a fire protection system 10, generally, as it is positioned upon a structure in which there was not quite enough space in the attic of the structure for the positioning of any of the water lines of the system. A false roof structure 54, generally, is held in place by support members 56, and sprinkler heads 18 are positioned upon false roof 54, and sprinkler heads 18 are connected to a separate water passage line 56, which is further connected as needed to holding tank 18. In FIG. 6 we indicate the positioning of a specialized form of holding tank 58, generally, having a removable cover 60 and supplied with a plastic net filter component 62.

Therefore, since many different embodiments of our invention may be made without departing from the spirit and scope thereof, it is to be understood that the specific embodiments described in detail herein are not to be taken in a limiting sense, since the scope of the invention is best defined by the appended claims

1. A Fire Protection System comprising:
A multiplicity of sprinkler components positioned on a structure, and each of said sprinkler components comprises a sprinkler head connected to a water line,
a water holding tank connected to a water supply line to receive water from a source of water, and connected to said water passage line to deliver water to said sprinkler components,
a water pump component connected to a source of electricity for operation, and connected to said water passage line to receive water from said water holding tank and to deliver water to said sprinkler components.

2. A Fire Protection System as described in claim 1, wherein:
Said each sprinkler component comprises a sprinkler head positioned on a first side of a component of said structure, a passage member sealably passing thru said component of said structure, and a portion of said water passage line positioned on a second side of said component of said structure.

3. A Fire Protection System as described in claim 2, wherein:
Said component of said structure comprises a side member of said structure.

4. A Fire Protection System as described in claim 3, wherein:
Said side member comprises a soffitt member.

5. A Fire Protection System as described in claim 1, wherein:
Said component of said structure comprises a roof member and said sprinkler component is positioned on said roof member.

6. A Fire Protection System as described in claim 5, wherein:
Said component of said structure further includes a side member of said structure.

7. A Fire Protection System as described in claim 6, wherein:
Said side member comprises a soffitt member.

8. A Fire Protection System as described in claim 1, wherein:
Said water holding tank is positioned underground near said structure and below an anticipated line of frost in the ground.

9. A Fire Protection System as described in claim 8, wherein:
Said water holding tank includes means for inspecting conditions of said tank.

10. A Fire Protection System as described in claim 9, wherein:
Said water holding tank includes an overflow valve.

11. A Fire Protection System as described in claim 10, wherein:
Said System includes an additional water holding tank.

12. A Fire Protection System as described in claim 1, wherein:
Said water pump component includes a switch member positioned interiorly of Said structure.

13. A Fire Protection System as described in claim 1, wherein:
Said source of electricity comprises a utility source of electricity.

14. A Fire Protection System as described in claim 1, wherein:
Said source of electricity comprises an assembly of batteries.

15. A Fire Protection System as described in claim 1, wherein:
Said System includes a water return line adaptable to collect water released on said Structure and deliver said water to said holding tank.

16. A Fire Protection System as described in claim 15, wherein:
Said water line includes a filter component.

17. A Fire Protection System as described in claim 2, wherein:
A portion of said structure comprises a support component for said sprinkler component, said support component mounted on a roof of said structure.
